(19) United States
(12) Patent Application Publication
(10) Pub. No.: US 2009/0044491 A1
(43) Pub. Date: Feb. 19, 2009

(54) METHOD OF CONTROLLING AN AUTOMATIC PRODUCTION/PACKING MACHINE

(75) Inventors: Gaetano DE PIETRA, Casalecchio Di Reno (IT); Verter CESARI, Granarolo Dell'Emilia (IT)

Correspondence Address: Clifford J. Mass;Ladas & Parry LLP, 26 West 61 Street, New York, NY, 10023, US

(73) Assignee: G. D SOCIETA' PER AZIONI.

(21) Appl. No.: 12/173,845

(22) Filed: Jul. 16, 2008

(30) Foreign Application Priority Data
Jul. 18, 2007 (IT) BO2007A 000486

(51) Int. Cl. B65B 57/00; G06F 19/00

(52) U.S. Cl. 53/396; 53/52; 53/507; 700/117

(57) ABSTRACT

A method of controlling an automatic production/packing machine having: at least one production line, along which a number of materials are fed and processed to produce an end product; a control unit for supervising operation of the automatic machine; and a number of electric/electronic operating components distributed along the production line.

### TECHNICAL FIELD

The present invention relates to a method of controlling an automatic production/packing machine.

The present invention may be used to advantage in an automatic machine for producing/packing cigarettes, to which the following description refers purely by way of example.

### BACKGROUND ART

Current automatic cigarette processing machines are highly complex mechanically, electrically and electronically. Over the past few years, conventional drives employing linkages to derive motion from a single electric motor have been replaced by a number of independent electric drives, each synchronized electronically with the others. Also, to improve product quality, increasingly sophisticated quality control checks have been introduced, both of the product itself (e.g. optical checks using television cameras) and process parameters (e.g. sealing temperature using heat sensors, packing material feed, etc.).

Once assembled, setting up an automatic machine is therefore a highly complex job involving a large number of operations (substantially checks and settings). At present, setup technicians work from hard copy setup lists of operations to be carried out, and tick off each operation on the list as it is completed. Such a method has several drawbacks, on account of the difficulty often encountered later in determining from hard copy setup lists if, how, when, and by whom a given operation was carried out.

In the case of electric/electronic operating components (e.g. motors, solenoid valves and sensors), setting up an automatic machine involves calibration parameter settings to compensate for tolerances, and operating parameter settings governing operation of the various production processes (e.g. the intervention thresholds of a temperature sensor). In currently marketed automatic machines, the same parameters of two supposedly identical machines have often been found to differ widely. For example, the heating temperature of a heating device for heat-shrinking plastic overwrapping on an automatic overwrapping machine may be 80° C. on one machine and 120° C. on another supposedly identical machine.

Substantial differences of this sort in the values of the same parameters on supposedly identical machines create serious problems, by making the machines difficult to run, preventing experience acquired on one machine from being applied to another, and inevitably creating a feeling of uncertainty among machine operators.

Moreover, an automatic cigarette processing machine has numerous (as many as a few hundred) sensors for detecting respective physical quantities, and connected to a control unit governing operation of the machine. In actual use, the control unit cyclically acquires the signals from the sensors, compares them cyclically with respective acceptance ranges, and signals an error/warning, by means of a corresponding error/warning text message, when the signal from at least one sensor falls outside the respective acceptance range.

In currently marketed automatic machines, each error/warning text message is written in substantially free (unstructured) form by a design engineer who attempts to explain the type of error in ordinary parlance; and the error/warning text messages must be translated into the languages of all the countries in which the machine is marketed. Being written in substantially free (unstructured) form in ordinary parlance, however, the error/warning text messages are often difficult to translate and, more importantly, are often translated inaccurately. Nor is the problem one to be taken lightly, seeing as how an automatic cigarette processing machine may be marketed worldwide in over fifty countries, many of which speak languages bearing no resemblance to Italian or English (e.g. China, Japan, India, Indonesia, Korea, Vietnam . . . ).

### DISCLOSURE OF THE INVENTION

It is an object of the present invention to provide a method of controlling an automatic production/packing machine, designed to eliminate the aforementioned drawbacks, and which at the same time is cheap and easy to implement.

According to the present invention, there is provided a method of controlling an automatic production/packing machine, as claimed in the attached Claims.

### BRIEF DESCRIPTION OF THE DRAWINGS

A non-limiting embodiment of the present invention will be described by way of example with reference to the accompanying drawings, in which:

FIG. 1 shows a schematic view in perspective of an automatic machine, in accordance with the present invention, for overwrapping packets of cigarettes;

FIGS. 2-11 show schematics of displays on a user interface device of the FIG. 1 automatic machine.

### PREFERRED EMBODIMENTS OF THE INVENTION

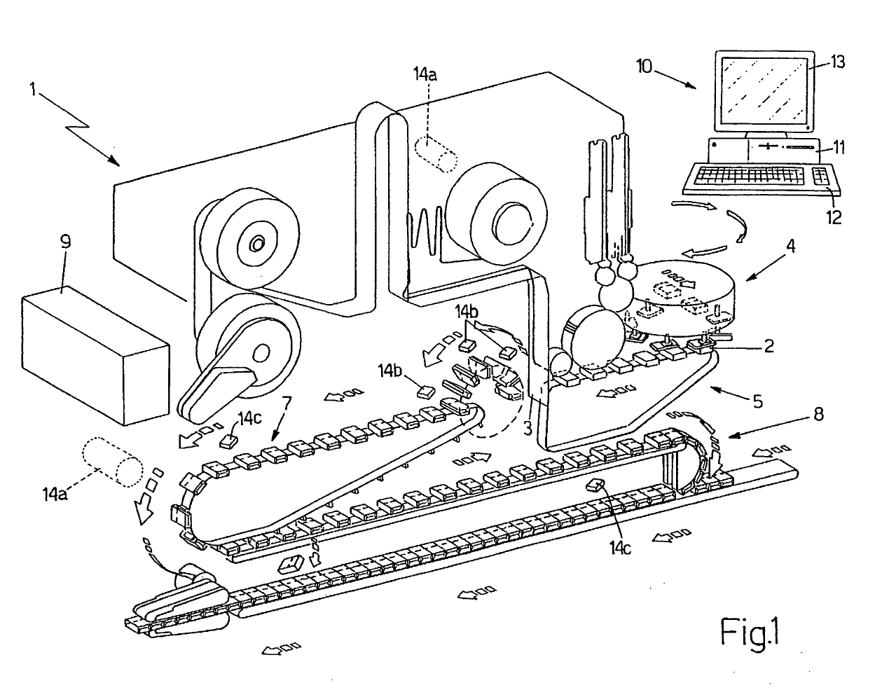

Number 1 in FIG. 1 indicates as a whole a known automatic machine (in particular, a G.D. S.p.a. “C800” machine) for overwrapping packets 2 of cigarettes in respective sheets 3 of transparent plastic packing material. In other words, automatic machine 1 comprises a production line, along which a number of materials (i.e. packets 2 of cigarettes and sheets 3 of packing material) are fed and processed to produce an end product, i.e. overwrapped packets 2 of cigarettes.

Automatic machine 1 comprises an input spider 4, which transfers packets 2 onto a belt conveyor 5, which feeds packets 2, together with respective sheets 3, to a packing wheel, on which tubular wrappings of sheets 3 are formed and heat sealed laterally about respective packets 2. The tubular wrappings are transferred from wheel onto a belt conveyor 7, which feeds the tubular wrappings along a path, along which the wrappings of sheets 3 about respective packets 2 are completed and heat sealed at the ends. From belt conveyor 7, packets 2 overwrapped in respective sheets 3 are transferred onto a drying conveyor 8, and from there onto a follow-up automatic cartoning machine (not shown in FIG. 1).

Automatic machine 1 also comprises a control unit 9 for governing operation of automatic machine 1, and which is connected to an interface (so-called HMI) device 10, by which an operator interacts with control unit 9. Interface device 10 comprises an industrial personal computer 11; an input device 12 (typically a keyboard and/or pointer) by which an operator transmits commands to control unit 9; and a screen 13 by which control unit 9 displays information. In a preferred embodiment, screen 13 also comprises a “touch-screen” device to simplify command entry by the operator as an alternative to input device 12.

Machine 1 also comprises a number of known electric/electronic operating components 14 (shown schematically) distributed along the production line and for performing respective functions when activated by control unit 9. For example, electric/electronic operating components 14 comprise electric motors 14a, solenoid valves 14b, and sensors 14c (shown schematically in FIG. 1 purely by way of example).

In a preferred embodiment, electric/electronic operating components 14 are connected to one another, and are connected to control unit 9 over a FieldBus control network; whereas interface device 10 and control unit 9 are connected to each other over an Ethernet computer network.

Control unit 9 has four different operating modes, which are accessed via interface device 10, normally by entering a password and/or inserting a physical key (e.g. a USB key), and which are: test (or setup), production (or run-time), configuration, and quality.

Test operating mode is designed exclusively for skilled operators responsible for setup and servicing of automatic machine 1, provides for displaying, and possibly altering, all the settings of automatic machine 1, and, as described below, provides for displaying all the setup operations performed when setting up automatic machine 1.

Production operating mode is designed for operators responsible for the normal running of automatic machine 1, and only provides information concerning operation of automatic machine 1.

Quality operating mode is designed for operators who actually work on automatic machine 1 during normal production, and provides the tools necessary to make any adjustments to automatic machine 1 directly affecting the end product. In other words, adjustments to automatic machine 1 not directly affecting the end product cannot be made in quality operating mode.

Configuration operating mode is designed for operators who actually work on automatic machine 1 during normal production, and provides the tools necessary to reconfigure and adapt automatic machine 1 to the manufacture of end products of a different size and/or brand. In other words, configuration operating mode permits a brand change, in which end product size remains unchanged and the type of packing material or the position of any labels is changed, and/or a size change in the end product.

It is important to note that each of the above operating modes is designed for a corresponding degree of skill of the operators of automatic machine 1, so that each operator works with tools suited to a specific level of skill in terms of comprehension, easy use, and the effect on automatic machine 1. In other words, skilled operators are allowed full scope, while less skilled operators are assisted as necessary and, more importantly, prevented from carrying out work wrongly because of a poor understanding of the display/work tools.

When designing automatic machine 1, all the setup operations of automatic machine 1 are analyzed and coded univocally and divided into a number of levels with a specific performance sequence.

When test operating mode is accessed by the operator on interface device 10, screen 13 of interface device 10 shows a main test display listing five setup operation levels and, for each level, the total number of setup operations in the level, and the number of setup operations already carried out. The setup operations in each level in the main test display can be expanded by means of a navigation tree which displays each setup operation in detail. The detailed display of each setup operation comprises an input tool (typically, a virtual button) by which to indicate completion of the setup operation. It is important to note that, when an input tool is operated to indicate completion of a setup operation, not only completion of the setup operation but also the identity of the operator and the date and time of completion are memorized.

In other words, all the setup operations of automatic machine 1 are memorized in a database in control unit 9 or interface device 10, and each assigned the corresponding level to which it belongs, so the setup operations of automatic machine 1 can be displayed in a main test display showing all the levels, and the setup operations in each level can be expanded by means of a navigation tree.

A preferred embodiment comprises the following five setup operation levels (listed in the order in which they are performed):

networks: operating checks of control and/or computer networks connected to control unit 9 (to determine the presence of control and/or computer networks, and whether the nodes of each network are all present and attainable);

wiring: checks to determine connection of control unit 9 to each electric/electronic operating component 14, and correct operation of each electric/electronic operating component 14 independently of the other electric/electronic operating components 14 (e.g. correct signal supply by sensors 14c, correct switching of solenoid valves 14b, and correct operation of electric motors 14a);

test run: prolonged no-load operation checks of each electric/electronic operating component 14, and of automatic machine 1 as a whole;

reel-off: checking and calibrating feed of each packing/production material independently of the other packing/production materials 2, 3;

packing: manufacture of pre-production products to check and calibrate the entire production process of automatic machine 1.

Some wiring-level setup operations comprise checking mechanical, electric, and operating conformance with design specifications of respective electric/electronic operating components 14. An electric/electronic operating component 14 conforms mechanically with design specifications if it has been correctly assembled mechanically (i.e. in the right position and using appropriate assembly means). An electric/electronic operating component 14 conforms electrically with design specifications if it responds correctly to electric signals, and may also be checked electrically by determining the values of tolerance-compensating calibration parameters. An electric/electronic operating component 14 conforms functionally with design specifications if it operates as designed, i.e. correctly performs the functions for which it was designed, and may also be checked functionally by determining the values of operating parameters governing production process performance (e.g. the intervention threshold of a temperature sensor 14c).

Operating at wiring level, it is also possible to force electric/electronic operating components 14 to a desired analog or digital value, to determine correct operation of an electric/electric operating component 14 or of another connected functionally to it. For example, it is possible to switch a solenoid valve 14b to a desired condition, or run an electric motor 14a in given test manner.

The detailed display of each setup operation at wiring level preferably shows (in text and/or graphic and/or multimedia mode) the information necessary to determine whether the corresponding electric/electronic operating component 14 conforms mechanically, electrically and functionally with design specifications.

In a preferred embodiment, it is possible to work back from the detailed display of a current setup operation to all the preceding setup operations related to the current one, i.e. all the preceding setup operations which, if performed wrongly, could affect the outcome of the current setup operation. The operator is thus able to determine how and when any wrongly performed preceding setup operations potentially affecting the outcome of the current setup operation were performed, and so debug the preceding setup operations efficiently (i.e. quickly and easily) and effectively (i.e. with guaranteed results).

In a preferred embodiment, when test operating mode is selected, display of all the error/warning messages is cut off, except for those relating to machine and operator safety of automatic machine 1.

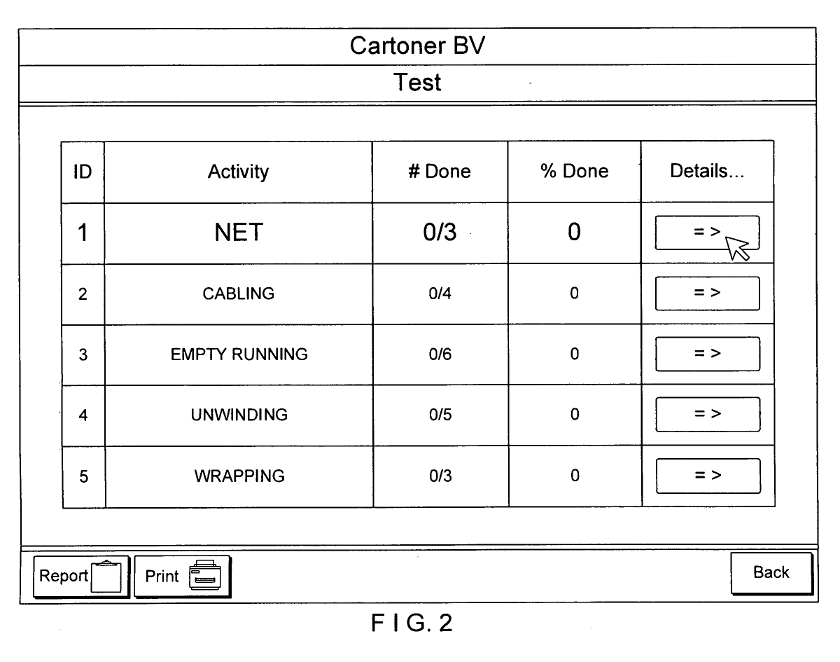

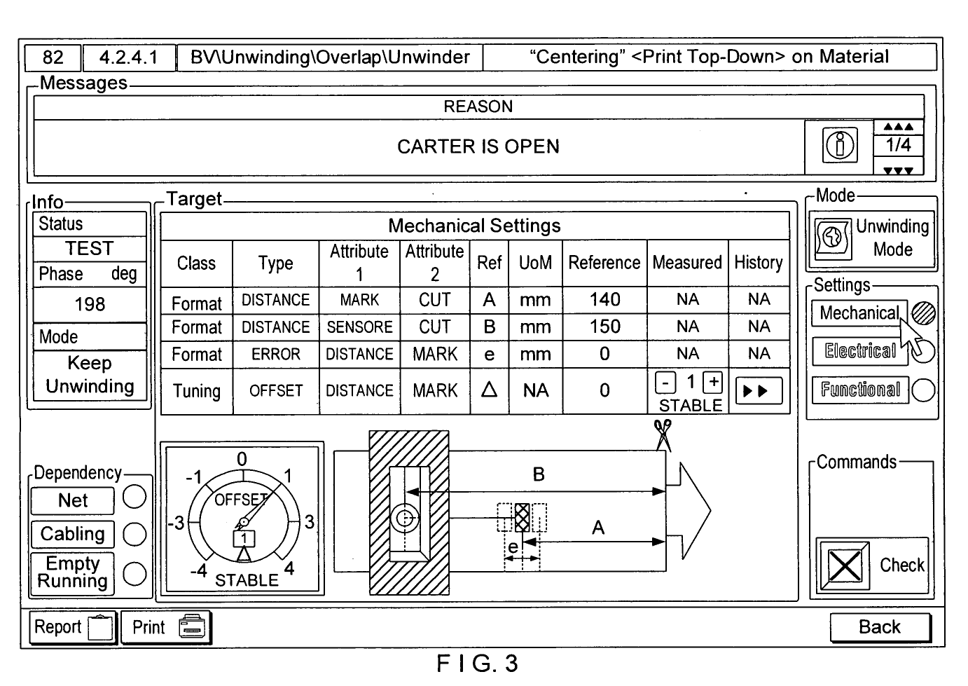

FIG. 2 shows an example of a main test display showing the five setup operation levels (networks, wiring, test run, reel-off, packing) and, for each level, the total number of setup operations in the level, and the number of setup operations already carried out. FIG. 3 shows an example of a detailed display of a packing-level setup operation, which relates to a cutting device for cutting a sheet 3 of packing material, and shows:
a list of operating parameters to be set (middle portion);
a schematic image of a sheet 3 of packing material, showing example measurements of the operating parameters to be set (bottom portion);
a drawing, which shows immediately whether the current reading of a sensor 14c is more or less correct (bottom portion).

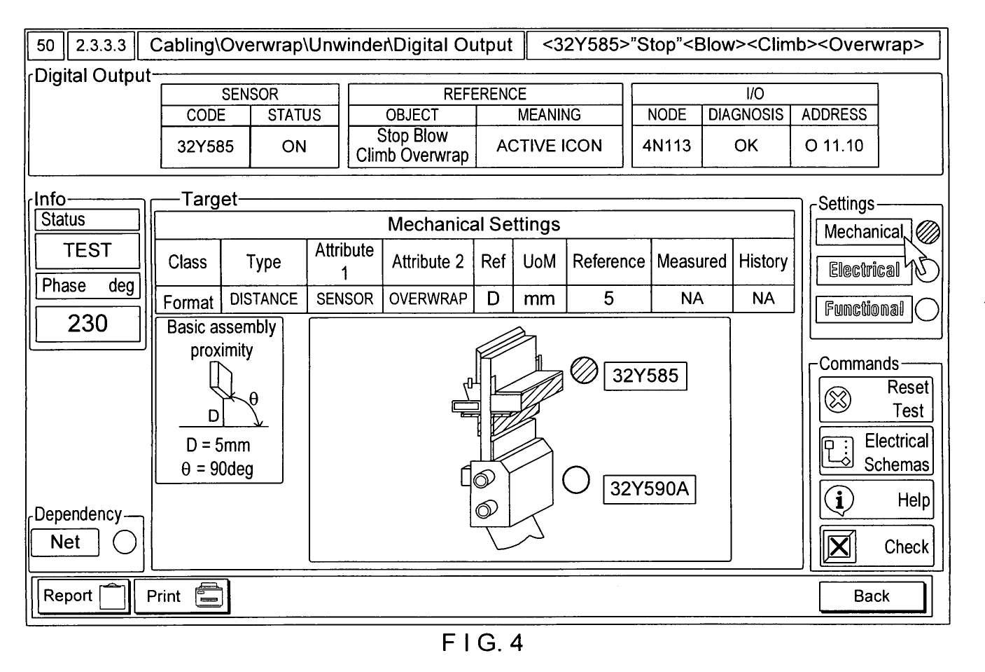

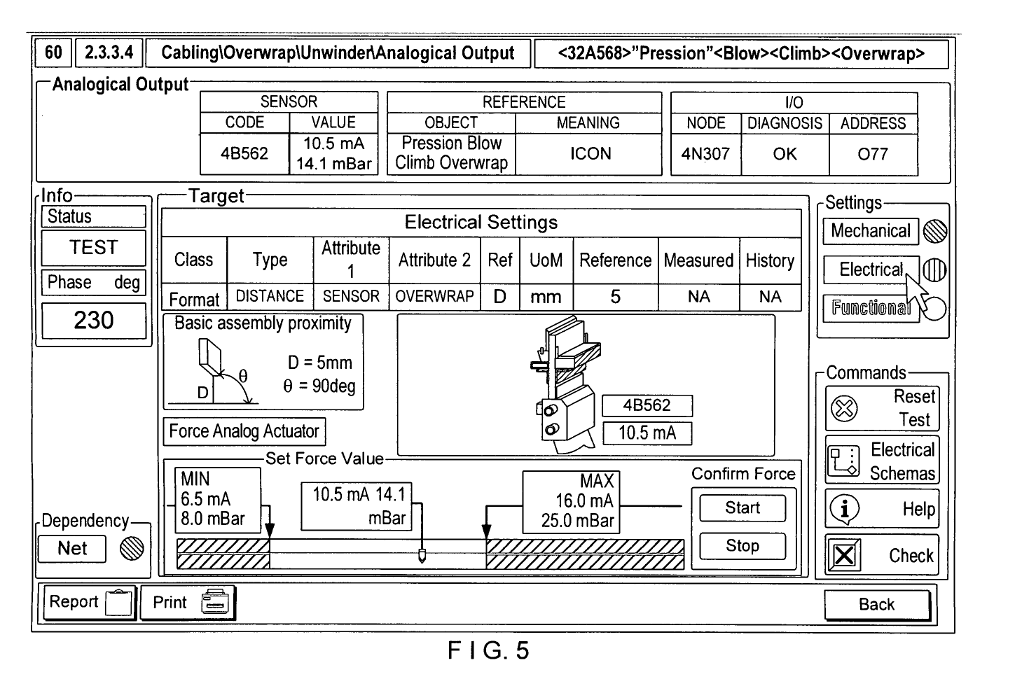

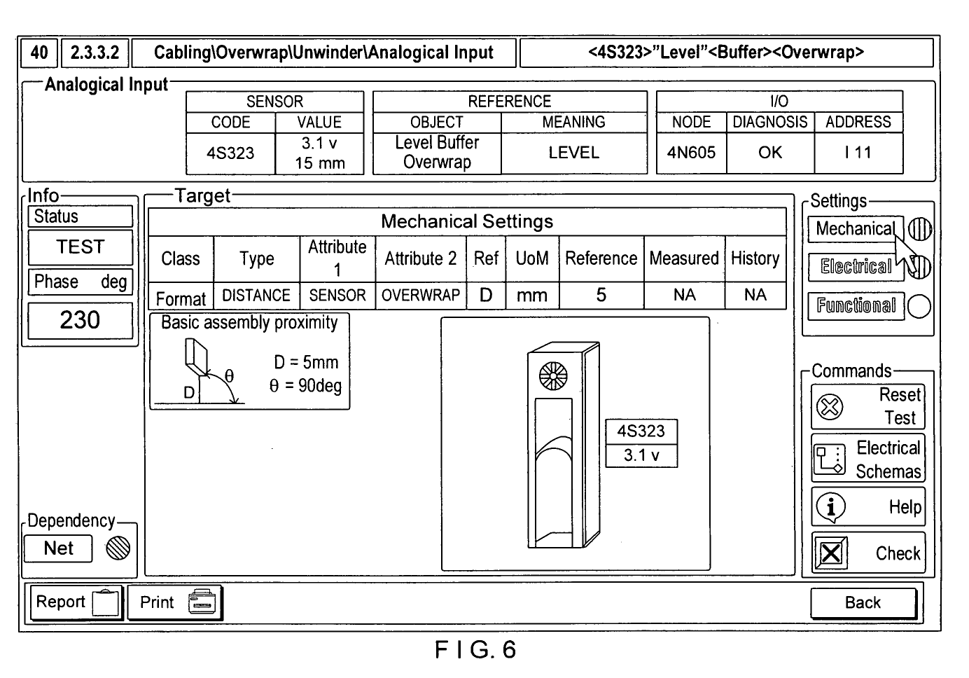

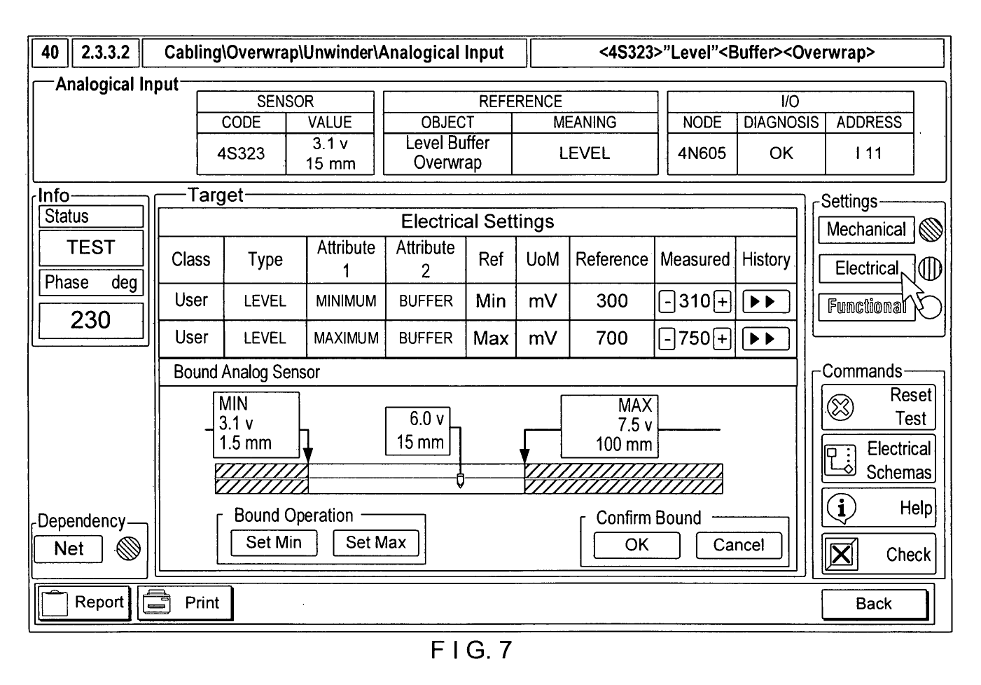

FIGS. 4-8 show further examples of detailed displays of wiring-level setup operations.

The above method of displaying and controlling setup of automatic machine 1 has numerous advantages, by being cheap and easy to implement, and enabling setup of automatic machine 1 efficiently (i.e. quickly, with no repetition of operations already carried out) and effectively (i.e. with no drawbacks of any sort). Moreover, completion of each setup operation is computer-recorded, indicating the operator carrying out the operation, and the date and time the operation was carried out, thus making it extremely easy, even some time after setup, to determine if, how, when, and by whom a given setup operation was performed.

As stated, during setup, control unit 9 memorizes the values of a set of calibration and operating parameters of electric/electronic operating components 14. In a preferred embodiment, when designing automatic machine 1, a pass range is established for each parameter of electric/electronic operating components 14, and comprises all the values assumable by the parameter, and an optimum range which is a subset of the pass range and comprises optimum parameter values. In other words, each parameter of electric/electronic operating components 14 may assume all the values in the respective pass range (i.e. the corresponding electric/electronic operating component 14 is physically capable of operating with all the values in the respective pass range), but, if an electric/electronic operating component 14 has been assembled correctly, each of its parameters should assume the values in the respective optimum range).

The pass and optimum parameter ranges of electric/electronic operating components 14 are memorized by control unit 9. When the operator, using interface device 10, assigns a respective pass range value to a parameter of electric/electronic operating components 14 (physical limits of the system prevent a value outside the pass range from being assigned), the parameter value is memorized by control unit 9 and simultaneously compared with the respective optimum range by interface device 10, which indicates when the parameter value is outside the respective optimum range.

When a parameter of an electric/electronic operating component 14 is outside the respective optimum range, interface device 10 indicates possible non-optimum assembly of electric/electronic operating component 14, and, if necessary, displays the information necessary to determine mechanical, electric, and functional conformance of electric/electronic operating component 14 with design specifications. In other words, a parameter of an electric/electronic operating component 14 outside the respective optimum range is assumed to be caused by non-optimum assembly of electric/electronic operating 14 (i.e. improper assembly, or proper assembly but far from the optimum established at the design stage). Non-optimum assembly of an electric/electronic operating component 14, in fact, makes it necessary to adopt anomalous parameter values of electric/electronic operating component 14 to compensate the effects of it not been perfectly assembled.

For example, in the case of a heating device for heat-shrinking plastic overwrapping, the heating temperature (constituting an electric parameter) of the heating device may be 80° C. if the heating device is assembled in the correct position (i.e. at the right distance from the plastic overwrapping conveyor), may be 100° C. if the device is assembled too far from the plastic overwrapping conveyor (i.e. a higher temperature of the heating device is required to heat the plastic overwrappings further away than normal), or may be 60° C. if the heating device is assembled too close to the plastic overwrapping conveyor (i.e. a lower temperature of the heating device is required to heat the plastic overwrappings closer than normal). In the above example, if the heating temperature of the heating device is outside the respective optimum range (e.g. between 70° C. and 90° C.), interface device 10 indicates possible improper assembly of the heating device.

Each optimum range may be divided into two parts (a passable subrange and a good subrange), or into three parts (a passable subrange, a fairly good subrange, and a good subrange) to give a more accurate assessment of the value of each parameter of electric/electronic operating components 14.

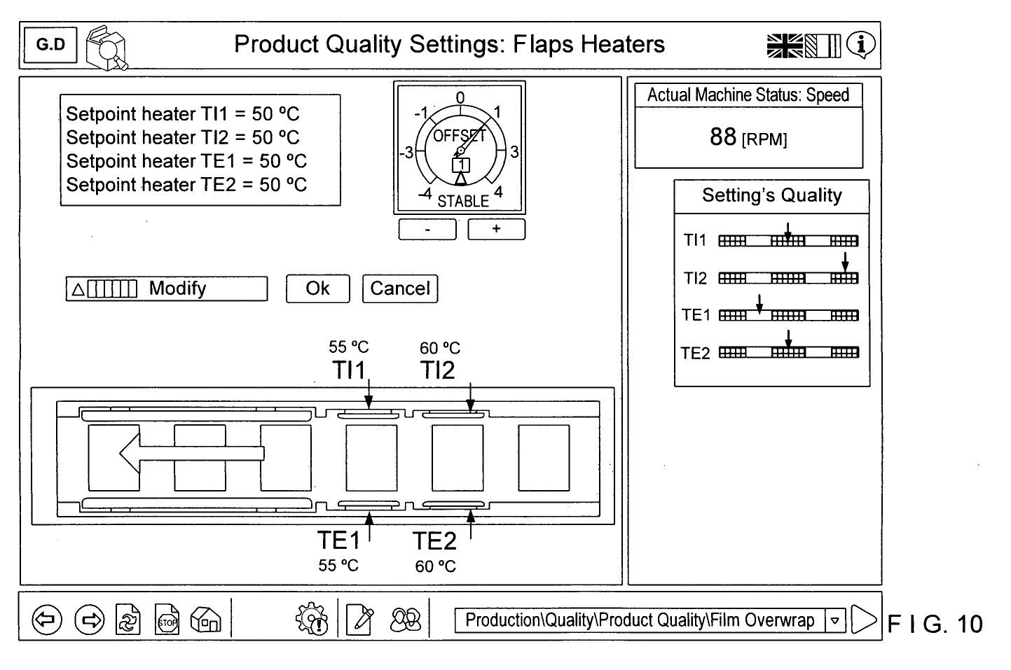

FIG. 10 shows an example display for adjusting electric parameters defined by the sealing temperatures of heat sealing devices. For each parameter, the window on the right indicates an assessment of how far the parameter deviates from the respective optimum range.

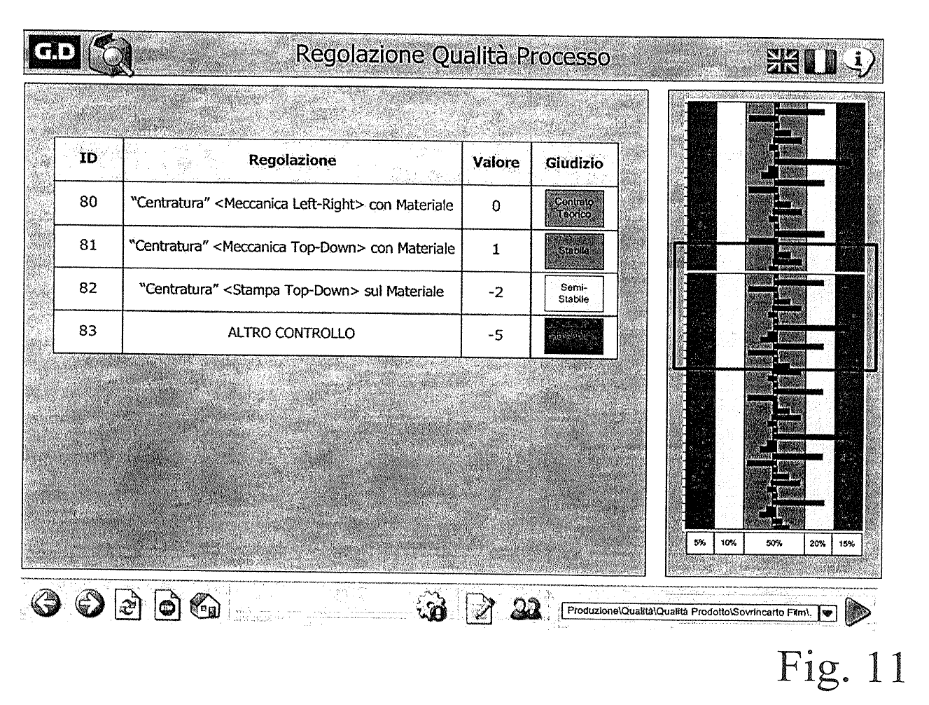

Interface device 10 may also show, in a comprehensive display of all the parameters of electric/electronic operating components 14 (as shown by way of example in FIG. 11), how many parameters fall within, and how many fall outside, the respective optimum ranges. Each parameter in the comprehensive display does not have its own measuring unit, but is normalized with respect to its optimum range.

The above method of controlling the parameters of electric/electronic operating components 14 has numerous advantages, by being cheap and easy to implement, by checking optimum assembly of electric/electronic components 14, and by achieving highly consistent parameter values of electric/electronic operating components 14 of identical automatic machines 1. In other words, the above method of controlling the parameters of electric/electronic operating components 14 prevents significant differences in the parameter values of two identical automatic machines 1, thus making the machines easier to run, by enabling the experience acquired on one automatic machine 1 to be applied to another.

As stated, a number of sensors 14c are connected to control unit 9, each for determining a physical quantity (temperature, presence, speed, position, appearance . . . ) involved directly or indirectly in the production process. As automatic machine 1 is running, control unit 9 acquires the signals from sensors 14c cyclically, compares the signals from sensors 14c cyclically with respective pass ranges indicating whether or not the signals are acceptable, and issues a text error/warning message if the signal from at least one sensor 14c falls outside the respective pass range. It is important to note that, depending on the sensor 14c supplying the out-of-range signal, and depending on the extent to which it deviates from the pass range, control unit 9 determines whether to generate a reject, an error or simple warning message, or also proceed to automatically shut down automatic machine 1.

When designing automatic machine 1, each sensor/group of sensors 14c is assigned a description of the process in which it is involved, and a description of the location of the sensor/group of sensors 14c on automatic machine 1. This information is memorized in control unit 9, so that each text error/warning message is generated by control unit 9 creating a text string comprising the process description and the location description, on automatic machine 1, of the sensor 14c supplying the out-of-range signal. In other words, as opposed to an error/warning assessment (almost always subjective and therefore potentially misleading), each text error/warning message simply contains an objective description of the process and the area of automatic machine 1 in which the anomaly has arisen (i.e. in which the sensor 14c supplying the out-of-range signal in involved and located respectively).

In a preferred embodiment, automatic machine 1 is divided into a number of macro-areas, areas, and sub-areas, so that each macro-area is divided into a number of areas, and each area is divided into a number of sub-areas, and the description of the location on automatic machine 1 of a sensor 14c is supplied by identifying (typically by name) the macro-area, area, and sub-area in which sensor 14c is located.

In a preferred embodiment, each text error/warning message is assigned a list of possible causes of the error/warning. When a text error/warning message is displayed, an error/warning display is generated containing the text error/warning message and relative cause list. The error/warning display may also contain a synoptic image of automatic machine 1, showing the location of the sensor 14c supplying the out-of-range signal; and an image of the portion of automatic machine 1 containing the sensor 14c supplying the out-of-range signal. Finally, the error/warning display may show a recording of the out-of-range signal measured by sensor 14c, and the corresponding expected signal (i.e. required by control unit 9).

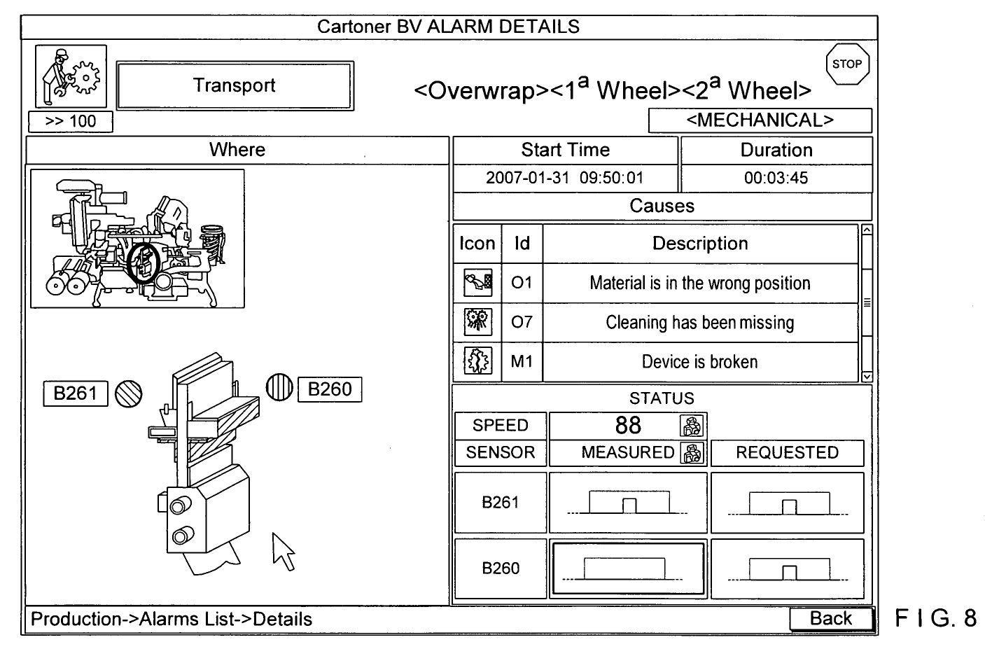

FIG. 8 shows an example embodiment of an error/warning display, which is displayed on screen 13 of interface device 10, and which shows:
a structured text error/warning message (at the top) indicating an anomaly in the “Transport” process, in the “Overwrap” macro-area, “Wheel 1” area, and “Wheel 2” sub-area;
the start time and duration of the anomaly (centre right);
a list of possible causes of the error/warning (centre right);
a synoptic image of automatic machine 1 showing the location of the sensor 14c supplying the out-of-range signal (centre left);
an image of the portion of automatic machine 1 containing the sensor 14c supplying the out-of-range signal (bottom left);
the out-of-range signal measured by sensor 14c, and the corresponding expected signal (bottom right); and
connection to the test page corresponding to the sensor 14c supplying the out-of-range signal (top left).

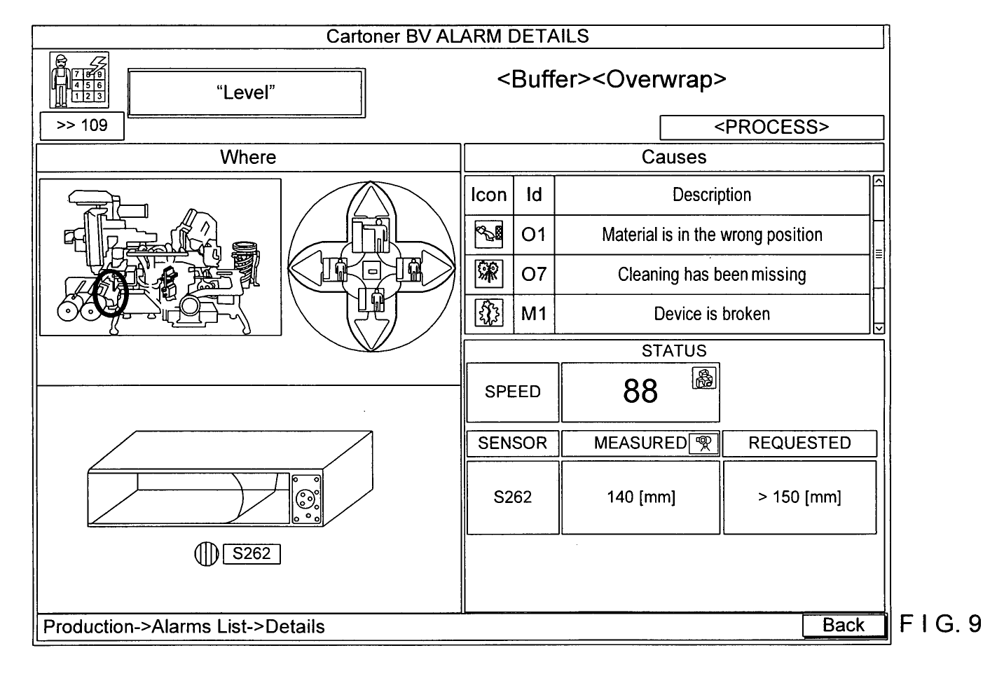

FIG. 9 shows a further example embodiment of an error/warning display, which is displayed on screen 13 of interface device 10, and is similar to the FIG. 8 embodiment, to the description of which the reader is referred.

The above method of generating text error/warning messages has numerous advantages, by being cheap and easy to implement, and by producing text error/warning messages that are efficient (i.e. concise), effective (i.e. indicate the problem objectively and accurately), and objective (i.e. with no personal, potentially misleading assessments). Moreover, the above method of generating text error/warning messages enables them to be translated faster (therefore more cheaply) and more easily (therefore more accurately) into all the languages of the countries in which automatic machine 1 is marketed.

1) A method of controlling an automatic production/packing machine comprising:
at least one production line, along which a number of materials (2, 3) are fed and processed to produce an end product;
a control unit (9) for supervising operation of the automatic machine (1); and
a number of electric/electronic operating components (14) distributed along the production line;
the method comprising the steps of:
dividing setup operations of the automatic machine (1) into a number of levels having a given order of performance;
memorizing the setup operations of the automatic machine (1) in a database in the control unit (9), each setup operation being assigned the corresponding level;
displaying the setup operations of the automatic machine (1) in a test display showing all the levels, and which allows expansion of the setup operations in each level by means of a navigation tree; and
inserting, for each setup operation, an input tool by which to indicate completion of the setup operation.

2) A method as claimed in claim 1, and comprising the following five levels listed in order of performance:
networks: operating checks of control and/or computer networks connected to the control unit (9);
wiring: checks to determine connection of the control unit (9) to each electric/electronic operating component (14), and correct operation of each electric/electronic operating component (14) independently of the other electric/electronic operating components (14);
test run: prolonged no-load operation checks of each electric/electronic operating component (14), and of the automatic machine (1) as a whole;
reel-off: checking and calibrating feed of each packing/production material independently of the other packing/production materials (2, 3);
packing: manufacture of pre-production products to check and calibrate the entire production process of the automatic machine (1).

3) A method as claimed in claim 2, wherein some setup operations at wiring level comprise checking mechanical, electric, and operating conformance of respective electric/electronic operating components (14) with design specifications.

4) A method as claimed in claim 3, and comprising the further step of displaying, for each setup operation at wiring level, information by which to determine mechanical, electric, and operating conformance of the corresponding electric/electronic operating component (14) with design specifications.

5) A method as claimed in claim 3, wherein some setup operations at wiring level comprise setting at least one operating or calibration parameter of respective electric/electronic operating components (14).

6) A method of controlling an automatic production/packing machine comprising:
at least one production line, along which a number of materials (2, 3) are fed and processed to produce an end product;
a number of electric/electronic operating components (14) distributed along the production line; and
a control unit (9) for supervising operation of the automatic machine (1), and which memorizes the values of a set of calibration and operating parameters of the electric/electronic operating components (14), which are used in interaction with the electric/electronic operating components (14);
the method comprising the steps of:
establishing, for each parameter of the electric/electronic operating components (14), a pass range comprising all the values assumable by the parameter; and
assigning each parameter of the electric/electronic operating components (14) a respective value, which falls within the pass range and is memorized in the control unit (9);
the method being characterized by comprising the steps of:
establishing, for each parameter of the electric/electronic operating components (14), an optimum range, which is a subset of the pass range and comprises the optimum values of the parameter;
comparing the value of each parameter of the electric/electronic operating components (14) with the respective optimum range; and
indicating when the value of a parameter of the electric/electronic operating components (14) falls outside the respective optimum range.

7) A method as claimed in claim 6, and comprising the further step of indicating possible non-optimum assembly of an electric/electronic operating component (14), when a parameter of the electric/electronic operating component (14) falls outside the respective optimum range.

8) A method as claimed in claim 7, and comprising the further step of displaying information by which to determine mechanical, electric, and operating conformance of the electric/electronic operating component (14) with design specifications.

9) A method as claimed in claim 6, wherein the optimum range is divided into a passable subrange and a good subrange.

10) A method as claimed in claim 6, wherein the optimum range is divided into a passable subrange, a fairly good subrange, and a good subrange.

11) A method as claimed in claim 6, and comprising the further step of displaying, in a comprehensive display of all the parameters of the electric/electronic operating components (14), how many parameters fall within the respective optimum ranges, and how many parameters do not fall within the respective optimum ranges.

12) A method of controlling an automatic production/packing machine comprising:
at least one production line, along which a number of materials (2, 3) are fed and processed to produce an end product;
a control unit (9) for supervising operation of the automatic machine (1); and
a number of sensors (14c), each for determining a physical quantity and connected to the control unit (9);
the method comprising the steps of:
cyclically acquiring the signals from the sensors (14c);
cyclically comparing the signals from the sensors (14c) with respective pass ranges; and
indicating an error/warning, by means of a corresponding text error/warning message, if the signal from at least one sensor (14c) falls outside the respective pass range;
the method being characterized by comprising the further steps of:
assigning to each sensor/group of sensors (14c) a description of the process in which the sensor/group of sensors (14c) is involved;
assigning to each sensor/group of sensors (14c) a description of the location of the sensor/group of sensors (14c) on the automatic machine (1); and
generating each text error/warning message by creating a text string comprising the process description assigned to the sensor (14c) supplying the out-of-range signal, and the location description, on the automatic machine (1), assigned to the sensor (14c) supplying the out-of-range signal.

13) A method as claimed in claim 12, and comprising the further steps of:
dividing the automatic machine (1) into a number of macro-areas, areas, and sub-areas, so that each macro-area is divided into a number of areas, and each area is divided into a number of sub-areas;
supplying the location description, on the automatic machine (1), of a sensor (14c) by identifying the macro-area, area, and sub-area in which the sensor (14c) is located.

14) A method as claimed in claim 12, and comprising the further steps of:
assigning each text error/warning message a list of possible causes of the error/warning;
generating an error/warning display containing the text error/warning message and associated list of possible causes; and
displaying the error/warning display.

15) A method as claimed in claim 14, wherein the error/warning display contains a synoptic image of the automatic machine (1) showing the location of the sensor (14c) supplying the out-of-range signal; and an image of the portion of the automatic machine (1) containing the sensor (14c) supplying the out-of-range signal.

16) A method as claimed in claim 14, wherein the error/warning display shows the out-of-range signal from the sensor (14c), and the corresponding expected signal.

17) A method as claimed in claim 14, wherein the error/warning display comprises a connection to a test page corresponding to the sensor (14c) supplying the out-of-range signal.
